(19) United States
(12) Patent Application Publication
(10) Pub. No.: US 2006/0140538 A1
(43) Pub. Date: Jun. 29, 2006

(54) Surface reflection type phase grating

(76) Inventors: Taisuke Isano, Utsunomiya-shi (JP); Ko Ishizuka, Saitama-shi (JP)

Correspondence Address: MORGAN & FINNEGAN, L.L.P., 3 WORLD FINANCIAL CENTER, NEW YORK, NY, 10281-2101, US

(21) Appl. No.: 11/317,790

(22) Filed: Dec. 22, 2005

(30) Foreign Application Priority Data
Dec. 24, 2004 (JP) 2004-373491

(51) Int. Cl. G02B 6/34

(52) U.S. Cl. 385/37

(57) ABSTRACT

A surface reflection type phase grating 21 in which first metal film 23 is formed on a substrate 22, metal gratings 24 of a rectangular cross-sectional shape having a thickness d for which first-order diffraction becomes maximum by second metal film 24 formed of a material differing from that of the first metal film 23 is formed thereon, and transparent dielectric film 26 formed of SiO₂ is further formed on the surfaces of the metal gratings 24 and the first metal film 23 exposed among them, and a displacement measuring apparatus adopting the surface reflection type phase grating.

### BACKGROUND OF THE INVENTION

1. Field of the Invention

This invention relates to a surface reflection type phase grating comprising a relief type diffraction grating formed on a substrate.

2. Related Background Art

There are known such a surface reflection type phase grating as disclosed, for example, in Japanese Utility Model Publication No. S61-39289, and a displacement measuring apparatus using the same.

This phase diffraction grating is formed as a relief type diffraction grating by forming a periodical groove on a glass substrate.

Further, reflection film of Au, Al or the like is vapor-deposited on the surface of this periodical groove, whereby an optical scale is constructed.

FIG. 7 of the accompanying drawings shows a cross-sectional view of an optical scale 1. A relief type diffraction grating 3 is formed on a substrate 2, and reflecting film 4 is vapor-deposited on the upper layer thereof.

A light beam is projected onto the relief type diffraction grating 3 formed on the substrate 2, and the diffracted reflected rights of the projected light beam are made to interfere with each other to thereby form an interference pattern. Further, this interference pattern is photoelectrically converted to thereby measure the displacement of the optical scale 1.

Such a relief type diffraction grating 3 can weaken the intensity of regular reflected right which is zero-order reflected and diffracted right by suitably determining the height of the groove. Then, as the result, the intensity of high-order reflected and diffracted lights used for the measurement can be intensified.

However, since the reflecting film 4 is vapor-deposited on the surface of the groove of the diffraction grating 3, the film thickness of the reflecting film 4 is fluctuated by the unevenness of vapor deposition. As the result, the shape and depth of the groove are varied and the quantity of the diffracted light may be fluctuated. Accordingly, under the influence of this fluctuation, there is the possibility that highly accurate measurement cannot be effected.

Also, as shown in FIG. 8 of the accompanying drawings, there is known a displacement measuring apparatus using an optical scale 11. (Japanese Patent Application Laid-open No. H2-25416).

In this optical scale 11, a relief type diffraction grating 13 is formed on the back of a transparent substrate 12, and reflecting film 14 is formed on the diffraction grating 13.

An interference pattern is formed by the use of diffracted lights produced by a light beam being applied from the front surface 15 side of the transparent substrate 12.

This interference pattern is photoelectrically converted, whereby the displacement of the optical scale 11 is measured.

In this optical scale 11, there are produced the reflected and diffracted lights of the light beam applied from the front surface 15 side and therefore, the fluctuation of the quantity of diffracted lights attributable to the fluctuation of the film thickness of the reflecting film 14 does not occur. Accordingly, there is obtained an optical scale of very high accuracy.

However, in the case of this back surface reflection type diffraction grating shown in FIG. 8, the light is transmitted through the transparent substrate 12 and therefore, under the influence of the reflection on the front surface 15 of the transparent substrate 12, the quantity of light is fluctuated.

Further, if the plate thickness of the transparent substrate 12 is made great in order to improve the rigidity of the transparent substrate 12, an optical path transmitted through the transparent substrate 12 will become long and the quantity of light will be decreased.

If conversely, the plate thickness of the transparent substrate 12 is made small in order to suppress the influence of transmitted light, the rigidity of the transparent substrate 12 will be reduced, and warp or flexure will be liable to occur to the transparent substrate 12. Under the influence of this flexure, there is the possibility that it may be come impossible to measure displacement highly accurately.

### SUMMARY OF THE INVENTION

It is an object of the present invention to solve the above-noted problems and to provide a surface reflection type phase grating which is easy to manufacture and is chemically stable. It is also an object of the present invention to provide a highly accurate displacement measuring apparatus adopting this phase grating.

A technical feature of the surface reflection type phase grating according to the present invention for achieving the above object is that first metal film is formed on a substrate, and a concavo-convex second phase grating pattern having periodical structure is formed on the first metal film by metal film. Here, the second film thickness is determined so as to be such film thickness that first-order diffraction by a light beam emitted from a light source used becomes greatest.

Also, a technical feature of the surface reflection type phase grating according to the present invention is that transparent dielectric film is formed on the phase grating pattern.

The etchants of the two kinds of metal film differ from each other and therefore, even if the metal film on a surface side worked into a grating shape comes off, the metal film on the underlayer is not etched. Therefore, the metal film on the surface side is formed with such a film thickness d that one time of diffraction of incident light becomes maximum, whereby it becomes unnecessary to accurately control a depth by etching.

Also, the light is reflected and diffracted by the metal film on the surface side and the metal film on the underlayer and therefore, the light does not pass through the substrate, and the loss due to the reflection or absorption by the glass substrate becomes null and therefore, diffracted light by greater intensity can be obtained.

Also, it becomes unnecessary to form reflection preventing film on the glass substrate and therefore, the aforedescribed problems can be solved.

Further, according to the surface reflection type phase grating according to the present invention, the upper portion of a metal grating is formed by dielectric film, whereby it can be made chemically stable.

It becomes possible to suppress the deterioration or corrosion of the metal film, and improve the physical strength of the grating, and accordingly, the durability thereof can be improved.

Also, since in the second metal film on the surface side and the first metal film on the substrate side, the light does not pass through the substrate, the loss of the light due to the reflection or absorption by the substrate does not occur and accordingly, diffracted light of greater intensity can be obtained.

The upper portion of the phase grating pattern is formed by a transparent dielectric material, whereby there is a loss due to reflection or absorption. However, the thickness of the transparent dielectric film is sufficiently small as compared with the thickness of the substrate and therefore, the loss is greatly smaller than in a back reflection grating type diffraction grating.

The above and other objects, features, and advantages of the invention will become more apparent from the following detailed description taken in conjunction with the accompany drawings.

### BRIEF DESCRIPTION OF THE DRAWINGS

FIG. 1 is a cross-sectional view of a surface reflection type phase grating according to Embodiment 1.

FIG. 2 is a flow chart of a manufacturing process.

FIG. 3 is a cross-sectional view of a modification.

FIG. 4 is a cross-sectional view of another modification.

FIG. 5 is a cross-sectional view of a surface reflection type phase grating according to Embodiment 2.

FIG. 6 is a cross-sectional view of a surface reflection type phase grating according to Embodiment 3.

FIG. 7 is a cross-sectional view of a surface reflection type phase grating according to the prior art.

FIG. 8 is a cross-sectional view of a back reflection type phase grating according to the prior art.

FIG. 9 shows the optical scale of the present invention mounted on a displacement measuring apparatus.

### DESCRIPTION OF THE PREFERRED EMBODIMENTS

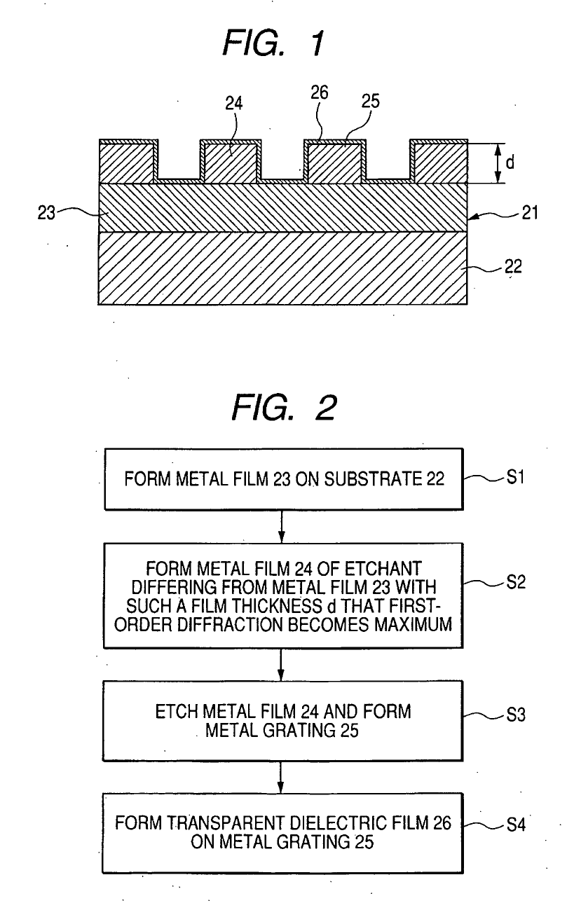

The present invention will hereinafter be described in detail with respect to some embodiments thereof shown in FIGS. 1 to 6.

### Embodiment 1

FIG. 1 is a cross-sectional view of a surface reflection type phase grating 21 having a relief type diffraction grating having a rectangular cross-sectional shape.

First metal film 23 is formed on a substrate 22.

On the first metal film 23, there are formed metal gratings 24 of a rectangular cross-sectional shape having a thickness d by second metal film formed of a material differing from that of the first metal film 23.

The thickness d of the metal gratings 24 is set so that first-order diffraction may become maximum.

Here, when n is the refractive index of the substrate, and λ is the wavelength of a light source used, the thickness d of the diffraction grating for which the first-order diffraction becomes maximum is d=nλ/4.

Further, on the surfaces of the metal gratings 24 and the first metal film 23 exposed among them, there is formed transparent dielectric film 26 formed of e.g. SiO₂ by CVD method.

As described above, the transparent dielectric film 26 formed of SiO₂ is formed on the first metal film 23 and the second metal film 24, whereby the first metal film 23 and the second metal film 24 are not exposed to the atmosphere and the quality of the film become stable. Accordingly, it never happens that the quantity of diffracted lights is decreased or fluctuated.

Accordingly, when the diffracted lights are made to interfere with each other by the surface reflection type phase grating 21, and any change in the light and darkness of the interference light is detected to thereby measure the amount of displacement of an object to be inspected, a stable output signal is obtained from a light receiving element.

As the result, it becomes possible to perform the measurement with high accuracy.

Also, the transparent dielectric film 26 in the present embodiment is formed of SiO₂, but besides SiO₂, use can be made of one or more of TiO₂, Ta₂O₅, ZrO₂, HfO₂, MgF₅ and Al₂O₃.

FIG. 2 shows a flow chart of the manufacturing process of this surface reflection type phase grating 21.

First, at a step S1, the first metal film 23 is formed on the substrate 22, whereafter at a step S2, the second metal film 24 of an etchant differing from that of the first metal film 23 is formed on the first metal film 23 so as to have a film thickness d for which first-order diffracted light becomes maximum.

Subsequently, at a step S3, the second metal film 24 on the surface side is etched to thereby form the metal gratings 24 of a rectangular cross-sectional shape, whereafter at a step S4, the transparent dielectric film 26 is formed on the metal gratings 24 by the use of e.g. CVD method.

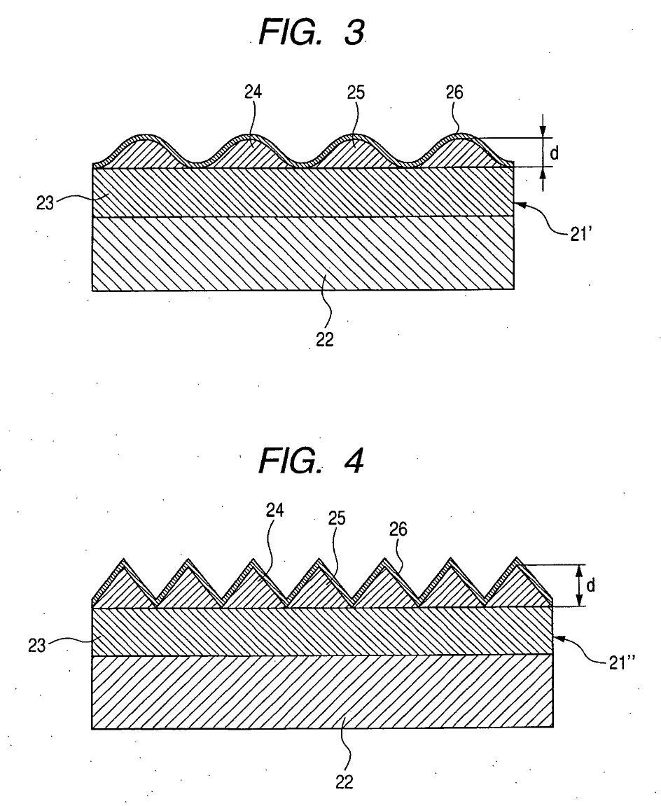

FIG. 3 shows a surface reflection type phase grating 21′ which is a modification in which a sine-save-shaped metal grating 24 is likewise formed.

FIG. 4 shows a surface reflection type phase grating 21″ which is a modification in which a triangular-wave-shaped metal grating 24 is likewise formed.

Each of the surface reflection type phase gratings 21, 21′ and 21″ comprises two layers, i.e., the first metal film 23 and the second metal film 24. The upper layer, i.e., the second metal film 24 is formed as a relief type diffraction grating having a depth d, and the transparent dielectric film 26 is further formed thereon.

Again in the surface reflection type phase gratings 21′ and 21″, an effect similar to that of the above-described surface reflection type phase grating 21 is obtained.

### Embodiment 2

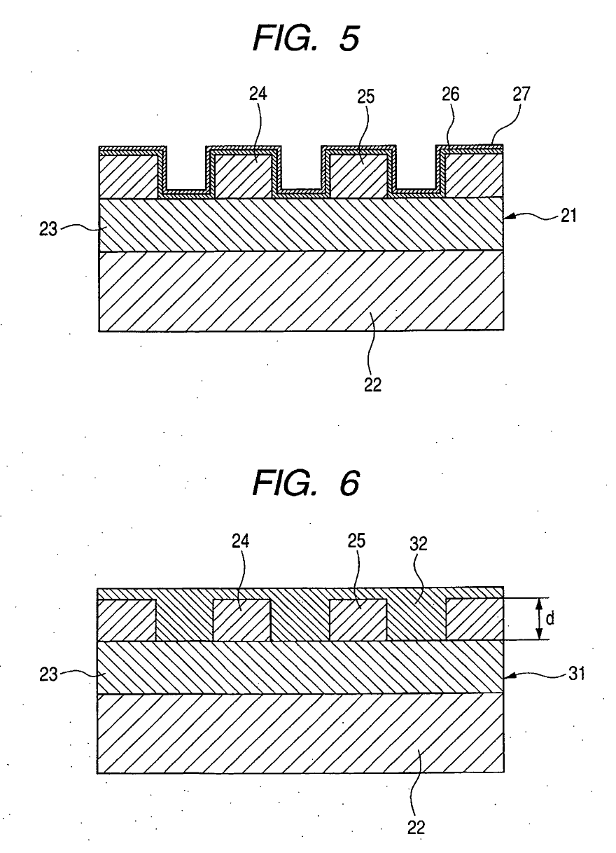

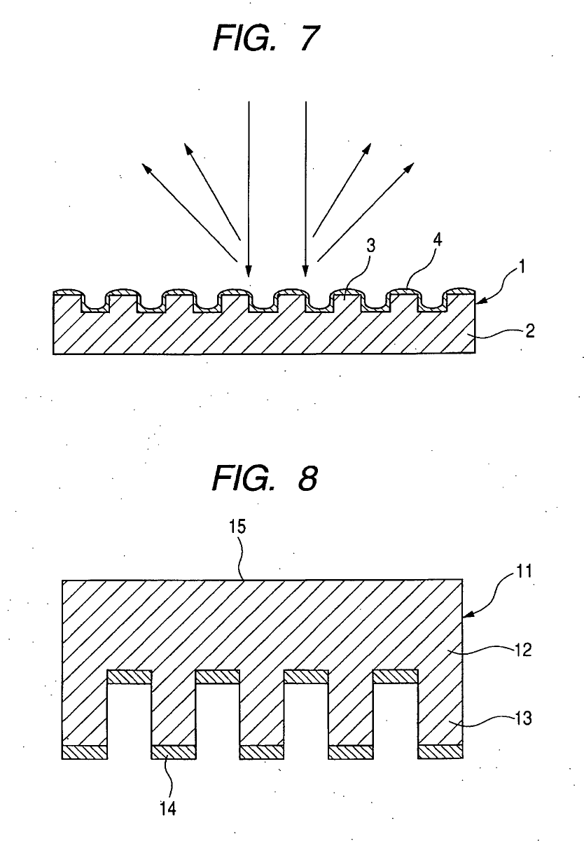

As in Embodiment 1, transparent dielectric film 26 comprising SiO₂ film is formed, whereafter as shown in FIG. 5, MgF₂ film 27 is further formed on the transparent dielectric film 26. The film thickness of this MgF₂ film 27 is designed such that transmittance becomes maximum.

In the case of this surface reflection type phase grating 21, light passes through the MgF₂ film 27 and the transparent dielectric film 26 formed of SiO₂, whereby a reflection preventing effect occurs, and the loss of the light can be suppressed. Accordingly, when diffracted lights produced by the surface reflection type phase grating 21 are made to interfere with each other, and any change in the light and darkness of the interference light is detected to thereby measure the amount of displacement of the object to be inspected, a stable output signal is obtained from a light receiving element, and still more highly accurate measurement becomes possible.

### Embodiment 3

FIG. 6 shows a cross-sectional view of a surface reflection type phase grating 31 according to Embodiment 3. In FIG. 6, the same members as those in Embodiment 1 are given the same reference characters.

In Embodiment 3, transparent dielectric film 32 formed of SiO₂ is embedded among metal gratings 24 and in the surfaces of the metal gratings 24.

Further, the surface of the embedded transparent dielectric film 32 is smoothed by CMP or the like, whereby the metal gratings 24 are not exposed to the atmosphere and accordingly, the strength of the metal gratings 24 is improved.

Again by adopting Embodiment 3, highly accurate measurement becomes possible as in the aforedescribed embodiments.

Again in Embodiment 3, as in Embodiment 2, MgF₂ film of a film thickness for which transmittance becomes thickness for which transmittance becomes maximum can be formed on the smoothed transparent dielectric film 32. By such a construction, a reflection preventing effect is provided and the loss of the light can be suppressed.

### Embodiment 4

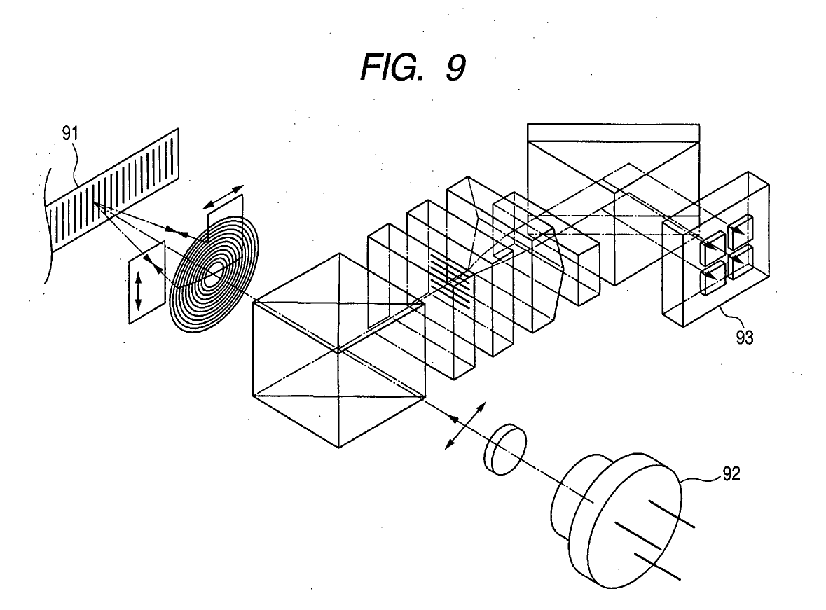

FIG. 9 shows an example in which the surface reflection type phase grating having the relief type diffraction grating shown in any one of Embodiments 1 to 3 is mounted as an optical scale on a displacement measuring apparatus.

The reference numeral 91 designates an optical scale using the surface reflection type phase grating having the relief type diffraction grating shown in any one of Embodiments 1 to 3.

The reference numeral 92 denotes a light source, e.g. a laser beam source.

The reference numeral 93 designates a light receiving element which causes light beams reflected and interfered with by the optical scale to interfere with each other, and receives the interference light and converts it into an electrical signal.

The converted signal is processed by a signal processing circuit, not shown, and thereafter is calculated by a calculation processing circuit (CPU), not shown, to thereby calculate the amount of relative displacement of the light source and the scale.

While in the present embodiments, there is disclosed an apparatus using a linear scale, use may also be made of a rotary type scale.

Also, of course, the optical system is not restricted to that of the present embodiment, but may be of any type.

As many apparently widely different embodiments of the present invention can be made without departing from the sprit and scope thereof, it is to be understood that the invention is not limited to the specific embodiment thereof except as defined in the appended claims.

This application claims priority from Japanese Patent Application No. 2004-373491 filed Dec. 24, 2004, which is hereby incorporated by reference herein.

What is claimed is:

1. A reflection type phase grating having:
a substrate;
first metal film formed on said substrate; and
a phase grating formed on the first metal film by second metal film, having periodical structure and having concavo-convex structure;
wherein the depth of said phase grating is set so that first-order diffracted light by an applied light beam may be maximum.

2. A reflection type phase grating having:
a substrate;
first metal film formed on said substrate; and
a phase grating formed on the first metal film by second metal film, having periodical structure and having concavo-convex structure;
wherein the depth of said phase grating satisfies a condition of
d=nλ/4,
when it is assumed that d is the depth of the phase grating, n is the refractive index of the substrate, and λ is the wavelength of a light source used.

3. A reflection type phase grating according to claim 1, wherein transparent dielectric film is formed on said phase grating.

4. A reflection type phase grating according to claim 1, wherein said first metal and said second metal film are metals differing in etchant from each other.

5. A reflection type phase grating according to claim 3, wherein said transparent dielectric film has the concavo-convex portion of said phase grating embedded therein, and the surface thereof is substantially smoothed.

6. A reflection type phase grating according to claim 3, wherein MgF₂ film is laminated on said transparent dielectric film.

7. A reflection type phase grating according to claim 3, wherein said transparent dielectric film includes at least one of SiO₅, TiO₂, Ta₂O₅, ZrO₂, HfO₂, MgF₂ and Al₂O₃.

8. A reflection type optical scale including:
a substrate;
first metal film formed on said substrate; and
a phase grating formed on the first metal film by second metal film, having periodical structure and having concavo-convex structure;
wherein the depth of said phase grating is set so that first-order diffracted light by an applied light beam may be maximum.

9. A reflection type optical scale including:
a substrate;
first metal film formed on said substrate; and
a phase grating formed on the first metal film by second metal film, having periodical structure and having concavo-convex structure;
wherein the depth of said phase grating satisfies a condition of
d=nλ/4,
when it is assumed that d is the depth of the phase grating, n is the refractive index of the substrate, and λ is the wavelength of a light source used.

10. A reflection type optical scale according to claim 8, wherein transparent dielectric film is formed on said phase grating.

11. A displacement measuring apparatus for measuring the amount of relative displacement of an optical scale and a light source, including:
a light source having coherence;
a reflection type optical scale having a substrate, first metal film formed on said substrate, and a phase grating formed on said first metal film, and having concavo-convex periodical structure;
wherein the depth of said phase grating is set so that the first-order diffracted light of a light beam applied from said light source may be maximum;
a light receiving element for detecting any change in the light and darkness of interference light produced by causing diffracted lights produced by said reflection type optical scale due to the light beam applied from said light source to interfere with each other, and converted it into an electrical signal; and
calculating means for calculating the amount of relative displacement of the optical scale and the light source on the basis of the electrical signal outputted from said light receiving element.

12. A displacement measuring apparatus for measuring the amount of relative displacement of an optical scale and a light source, including:
a light source having coherence;
a reflection type optical scale having a substrate, first metal film formed on said substrate, and a phase grating formed on said first metal film, and having concavo-convex periodical structure, wherein the depth of said phase grating satisfies a condition of “d=nλ/4”, when it is assumed that d is the depth of the phase grating, n is the refractive index of the substrate, and λ is the wavelength of a light source used;
a light receiving element for detecting any change in the light and darkness of interference light produced by causing diffracted lights produced by said reflection type optical scale due to the light beam applied from said light source to interfere with each other, and converted it into an electrical signal; and
calculating means for calculating the amount of relative displacement of the optical scale and the light source on the basis of the electrical signal outputted from said light receiving element.

13. A displacement measuring apparatus according to claim 11, wherein transparent dielectric film is formed on said phase grating.

14. A displacement measuring apparatus according to claim 11, wherein said first metal film and said second metal film are metals differing in etchant from each other.

15. A displacement measuring apparatus according to claim 13, wherein said transparent dielectric film has the concavo-convex portion of said phase grating embedded therein, and the surface thereof is substantially smoothed.

16. A displacement measuring apparatus according to claim 13, wherein MgF₂ film is laminated on said transparent dielectric film.

17. A displacement measuring apparatus according to claim 13, wherein said transparent dielectric film includes at least one of SiO₃, TiO₂, Ta₂O₅, ZrO₂, HfO₂, MgF₂ and Al₂O₃.

18. A method of manufacturing an optical scale for use in a displacement measuring apparatus for measuring the amount of relative displacement of the optical scale and a light source, including:
a first step of forming film on a substrate by first metal;
a second step of forming second metal film of an etchant differing from that of said first film with a thickness for which first-order diffracted light produced by said light source becomes maximum, on the film formed at said first step; and
a third step of etching the second metal film formed at said second step to thereby manufacture a metal grating.

19. A method of manufacturing an optical scale for use in a displacement measuring apparatus for measuring the amount of relative displacement of the optical scale and a light source, including:
a first step of forming film on a substrate by first metal;
a second step of forming second metal film of an etchant differing from that of said first film with a thickness satisfying a condition of
“d=nλ/4”, when it is assumed that d is the thickness of the second metal film, n is the refractive index of the substrate, and λ is the wavelength of a light source used, on the film formed at said first step; and
a third step of etching the second metal film formed at said second step to thereby manufacture a metal grating.

20. A method according to claim 18, further having:
a fourth step of forming transparent dielectric film on said metal grating.

21. A reflection type phase grating according to claim 2, wherein transparent dielectric film is formed on said phase grating.

22. A reflection type phase grating according to claim 2, wherein said first metal and said second metal film are metals differing in etchant from each other.

23. A reflection type optical scale according to claim 9, wherein transparent dielectric film is formed on said phase grating.

24. A displacement measuring apparatus according to claim 12, wherein transparent dielectric film is formed on said phase grating.

25. A displacement measuring apparatus according to claim 12, wherein said first metal film and said second metal film are metals differing in etchant from each other.

26. A method according to claim 19, further having:
a fourth step of forming transparent dielectric film on said metal grating.
